(19) United States
(12) Patent Application Publication
(10) Pub. No.: US 2022/0036781 A1
(43) Pub. Date: Feb. 3, 2022

(54) DISPLAY DEVICE

(71) Applicant: SHARP KABUSHIKI KAISHA, Osaka (JP)

(72) Inventor: KAZUHIKO YODA, Osaka (JP)

(21) Appl. No.: 17/387,577

(22) Filed: Jul. 28, 2021

Related U.S. Application Data
(60) Provisional application No. 63/058,879, filed on Jul. 30, 2020.

(51) Int. Cl. G09G 3/00; G09G 3/36

(52) U.S. Cl. CPC G09G 3/006; G09G 2380/10; G09G 3/36

(57) ABSTRACT

An in-vehicle display device is disclosed which is connected to a host via a video communication interface and performs displaying under the control of the host. The display device includes a control unit that controls the display device, and a storage unit accessible by the control unit. When the control unit detects an occurrence of an error in the display device, the control unit stores error event data representing the error in the storage unit.

### BACKGROUND

### 1. Field

The following disclosure relates to a display device, and more particularly to a display device used as an in-vehicle display module.

### 2. Description of the Related Art

In recent years, in many cases, a high-definition display has been incorporated into an instrument panel of a vehicle in order to present various information such as navigation information and information indicating a driving state of the vehicle to a driver and a passenger of the vehicle. In general, such an in-vehicle display is configured as a display module having only a display function, and displaying thereof is controlled by a host device (a host). The host processes data collected from various parts of the vehicle via an in-vehicle network, generates display data, and sends the generated display data to the display module. The display module displays the received display data.

Not only in the case of the in-vehicle displays but in any display that operates under the control of the host according to display data provided from the host, when a defect occurs in displaying, a process may be performed to determine whether the display or the host causes the defect. For example, Japanese Unexamined Patent Application Publication No. 2008-28581 discloses a mechanism for facilitating analysis of error contents in a receiving device such as a television broadcast receiver having a digital tuner. When an error occurs, if it is possible to acquire date/time information based on the digital tuner, the receiving device stores the date/time information. However, in a case where it is difficult to acquire the date/time information based on the digital tuner, the receiving device stores a cumulative operating time in the device. In addition, error information including date/time information can be displayed on the display in a service mode for a service person or in a user mode for a user, which facilitates analysis of error contents.

The above-described receiving device according to the conventional technique is one of consumer devices such as a television broadcast receiver, and thus it is possible to make on-site error analysis by displaying the error information on the display. However, in the case of an in-vehicle display, when a defect occurs in the display, it is difficult to perform an error analysis while keeping the display in a state in which the display is installed on the vehicle, because the host usually does not have an error analysis function. In relatively many cases, when a defect occurs in an in-vehicle display module, a screen of the display module is in a state (light-off state) in which nothing is displayed. Such a phenomenon may be caused by a problem with the display module, or by a problem with the host or a problem with the communication between the display module and the host. However, in most cases, the display module is replaced and only the removed display module is returned to a display manufacturer, while the cause of the defect is unknown. In this case, even if only the returned display module is examined, it may be difficult to identify the cause of the defect without the host used together with the display.

### SUMMARY

According to an aspect of the disclosure, there is provided an in-vehicle display device which is connected to a host via a video communication interface and performs displaying under the control of the host. This display device includes a control unit that controls the display device, and a storage unit accessible by the control unit. When the control unit detects an occurrence of an error in the display device, the control unit stores error event data indicating the error in the storage unit.

### BRIEF DESCRIPTION OF THE DRAWINGS

FIG. 1 is a block diagram showing an outline of a functional configuration of a display device (a display module) according to an embodiment, wherein the display device is mounted in a vehicle and is in a normal operation;

FIG. 2 is a diagram showing a state in which the display module shown in FIG. 1 is removed from the vehicle and connected to an analysis tool for defect analysis;

FIG. 3 is a schematic diagram showing an example of a format of an EEPROM shown in FIG. 1;

FIG. 4 is a schematic diagram showing an example of a format of event data;

FIG. 5 is a schematic diagram showing an example of a format of ON/OFF event data;

FIG. 6 is a schematic diagram showing an example of a format of error event data; and

FIG. 7 is a sequence diagram showing an example of a procedure of storing an error event.

### DESCRIPTION OF THE EMBODIMENTS

Embodiments of the present disclosure are described in detail below with reference to drawings. The same or corresponding parts in the drawings are denoted by the same reference numerals, and a duplicated description thereof is omitted.

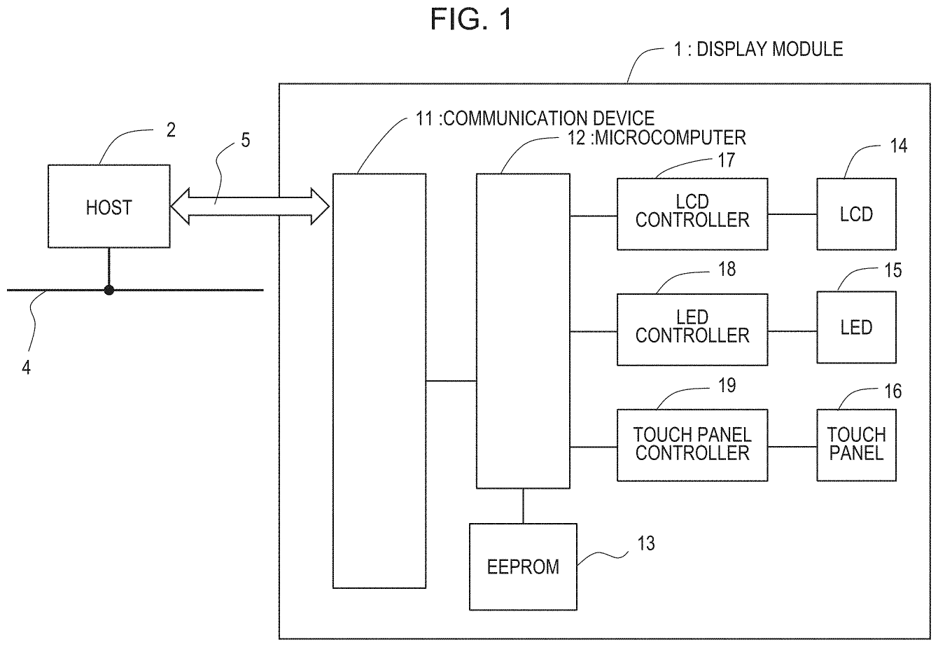

FIG. 1 is a block diagram showing an outline of a functional configuration of a display device (a display module) 1 according to an embodiment. The display module 1 is incorporated, as an in-vehicle display, in an instrument panel of a vehicle. The display module 1 displays various kinds of information in the form of an image, such as navigation information, information indicating a driving state of the vehicle, and/or the like. During a normal operation, the display module 1 is connected to the host 2 via a video communication interface 5 as shown in FIG. 1 such that the display module 1 receives control data and display data from the host 2, and operates based thereon. The video communication interface 5 may use, by way of example but not limitation, an FPD-LINK serial interface standard. The host 2 is connected to various parts of the vehicle via an in-vehicle network 4 such as CAN (Control Area Network) thereby controlling the various parts of the vehicle.

The display module 1 according to the present embodiment is a liquid crystal display device having a backlight and having a touch panel function. However, the configuration of the display module 1 is not limited to that described above, and any type of display device other than the liquid crystal display device may be used. The touch panel function is not indispensable. As shown in FIG. 1, by way of example, the display module 1 includes a communication device 11, a microcomputer 2, an EEPROM (Electrically Erasable Program Read-Only Memory) 13, an LCD (Liquid Crystal Display) 14, an LED (Lighting Eight) 15, a touch panel 16, an LCD controller 17, an LED controller 18, and a touch panel controller 19.

The communication device 11 has a function of a deserializer for converting serial data to original parallel data. The microcomputer 12 controls the LCD controller 17, the LED controller 18, the touch and, controller 19, and the like in the display module 1, and also controls writing of data into the EEPROM 13.

The LED 15 functions as a backlight of the LCD 14. An ON/OFF operation, brightness, and the like thereof are controlled by the LED controller 18. The LCD controller 17 controls displaying of the LCD 14. The touch panel controller 19 controls the touch panel 16 to detect a touch operation on the display module 1 performed by a user. The touch panel 16 may be configured separately from the LCD 14, or may be incorporated in the LCD 14.

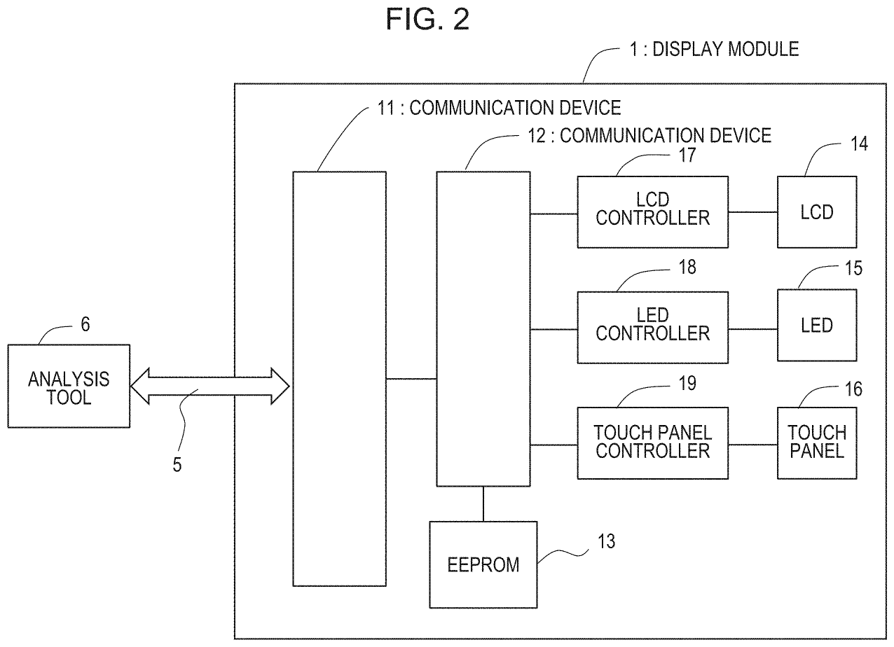

When the microcomputer 12 detects a change in the state of the display module 1 in the normal operation, the microcomputer 12 stores data (event data) indicating the content of the state change in the EEPROM 13. When some defect (error) occurs in the display module 1, the event data includes data (error data) indicating the error. By storing the event data in the EEPROM 13, it becomes possible to analyze the cause of the error after the display module 1 is removed from the vehicle by connecting an analysis tool 6 to the display module 1 and reading out the event data from the EEPROM 13 as shown in FIG. 2. The analysis tool 6 is generally realized using a personal computer or the like, and is connected to the display module 1 via the video communication interface 5 based on, for example, the FPD-LINK serial interface standard.

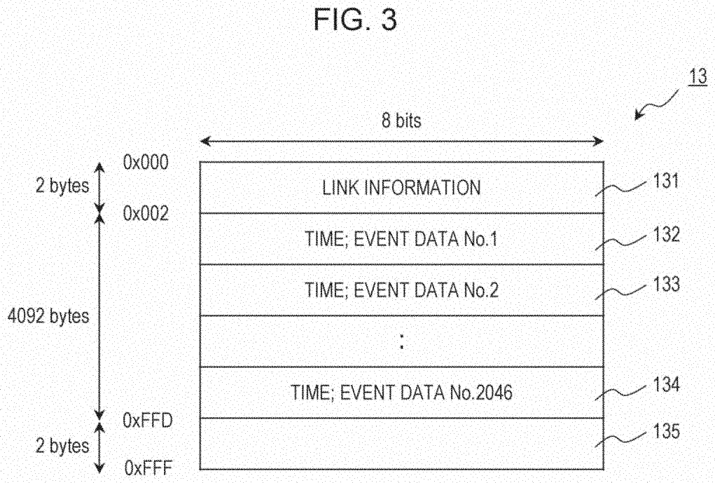

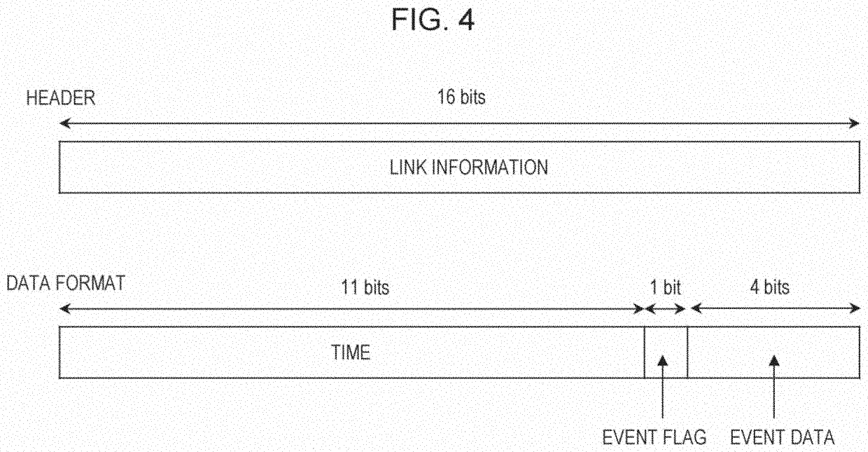

Next, the EEPROM 13 is described below. FIG. 3 is a schematic diagram illustrating an example of a format of the EEPROM 13. In the example shown in FIG. 3, the EEPROM 13 has a storage area of 4 Kbits (4096 bytes), and its address is specified by 12 bits. As shown in FIG. 3, the EEPROM 13 has a 16-bit area 131 at the beginning thereof for writing link information (Link information). The link information has a data length of 16 bits as shown in an upper part of FIG. 4, and indicates a start address (a Write position) of a currently-writable area in the EEPROM 13.

Each time a change in the state of the display module 1 is detected, the microcomputer 12 writes event data in the EEPROM 13. The event data has a length of 16 bits, and data is sequentially written in the EEPROM 13 starting from an area 132 (with an address of 0x002) of the EEPROM 13. In the EEPROM 13, as shown in FIG. 3, a total of 2046 pieces of event data can be stored over the areas 132, 133, . . . , 134. In the EEPROM 13, an end area 135 with 2 bytes is a reserve area for checking the operation of the EEPROM 13. When the write address exceeds 0xFFD, the link information is reset to 1, and writing is performed from the address of 0x002 (the area 132).

As shown in a lower part of FIG. 4, the event data includes 11-bit data indicating an event occurrence time (Time), a 1-bit event flag (Event flag), and 4-bit event data (Event data). The time data has a length of 11 bits, and thus it is possible to represent as many points of time as 2 to the 11th power. Therefore, when time is represented in steps of minutes, it is possible to represent time every minute over a period of 2048 minutes (about 34.1 hours). When the event flag is “0”, the event data is ON/OFF event data. On the other hand, when the event flag is “1”, the event data is error event data. That is, the ON/OFF event data is normal event data, and the error event data is abnormal event data.

As described above, in the present embodiment, in addition to the error event data indicating an occurrence of an error, the ON/OFF event data indicating a change in the ON/OFF state of the display module 1 is also stored in the EEPROM 13. By storing not only the error event data but also the ON/OFF event data in the EEPROM 13, it becomes possible to determine whether or not the display module 1 is correctly turned on/off before and after the error occurs by analyzing the error.

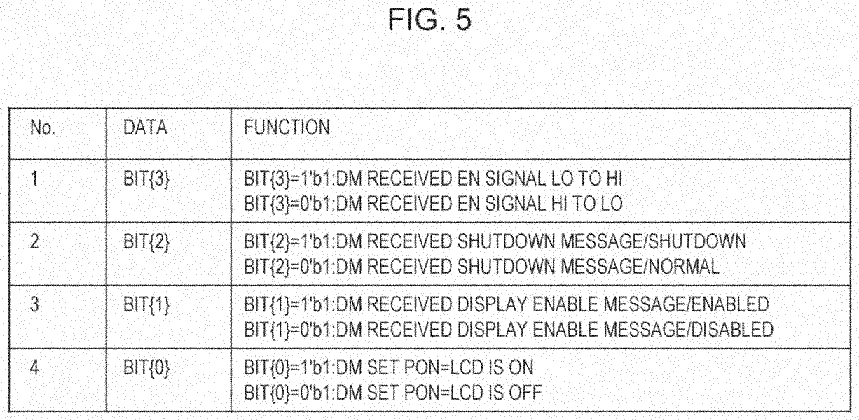

FIG. 5 is a schematic diagram showing an example of a format of ON/OFF event data. In the example shown in FIG. 5, among 4 bits of the event data, the most significant bit BIT{3} represents a change in an enable (EN) signal given to the display module 1. In a case where a change in the enable signal from a low level (Lo) to a high level (Hi) is detected, “1” is set in the BIT{3}. On the contrary, in a case where it is detected that the enable signal is changed from the high level (Hi) to the low level (Lo), “0” set in the BIT{3}.

BIT{2} of the event data indicates whether or not a shutdown message (Shutdown Message) to the display module 1 is received. When the shutdown message is received, if argument data thereof is 1b (Shutdown), “1” is set in BIT{2}. In a case where a shutdown message is not received, or in a case where although a shutdown message is received, argument data is 0b (Normal), “0” is set in BIT{2}.

BIT{1} of the event data indicates the state of a display enable message (Display Enable Message). When the display enable message is Enabled (turn on), “1” is set in BIT{1}. When the display enable message is Disabled (turn off), “0” is set in BIT{1}.

The least significant bit, BIT{0}, of the event data indicates an on/off state (PON=LCD) of the LCD 15. When the LCD 15 is in an on-state, “1” is set in the BIT{0}. When the LCD 15 is in an off-state, “0” is set in the B{0}.

When the microcomputer 12 detects an occurrence of an ON/OFF event, the microcomputer 12 generates ON/OFF event data according to the above-described format, and stores it in the EEPROM 13. Note that the format of the ON/OFF event data described above is merely an example. It is allowed to arbitrarily set a data type and a format for the event data.

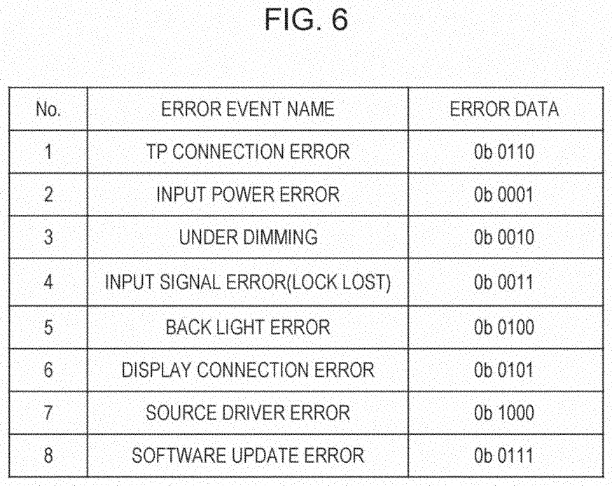

In a case where any error event occurs, the microcomputer 12 generates error event data and stores it in the EEPROM 13. As described above, when error event data is generated, “1” is set in the event flag. FIG. 6 is a schematic diagram showing an example of a format of error data included in error event data. In the example shown in FIG. 6, specific error data (Error data) is set in each of eight types of error events. These pieces of error data are stored in the form of, for example, a table in a memory accessible by the microcomputer 12. When the microcomputer 12 detects an error, the microcomputer 12 acquires error data according to a content of the error from the table, generates error event data, and stores the generated error event data in the EEPROM 13.

For example, when a connection error (a TP connection error) in the touch panel 16 is detected, the microcomputer 12 checks the connection of the touch panel 16. If it is turned out that the connection is not established, the microcomputer 12 stores “0110” as error data in 4-bit event data shown in a lower part of FIG. 4. Note that in the case of this error, the error is not reported from the microcomputer 12 to the host 2.

When it is detected that the input voltage applied to the display module 1 has become low (Input power error), the microcomputer 12 stores “0001 (in binary number)” as error data. Also in this case, the error is not reported from the microcomputer 12 to the host 2.

When dimming is executed (Under dimming), the microcomputer 12 stores “0010 (in binary number)” as error data. In this case, the microcomputer 12 reports the error by setting a Dimming flag of the Status message sent to the host 2.

When an input signal error (Input Signal error), more specifically, when a LOCK lost error occurs, the microcomputer 12 stores “0011 (in binary number)” as error data. In this case, the microcomputer 12 reports the error by setting a LOCK lost flag of the Status message sent to the host 2.

In a case where the LED controller 18 outputs a failure signal, the microcomputer 12 determines that a backlight error (Backlight error) has been detected, and stores “0100 (in binary number)” as error data. In this case, in addition to the error event data, the values of the FAULT register and the LED FAULT register are read from the LED controller 18 and stored in a 2-byte area following the error event data. Thus, in this case, a total of 4 bytes of error event data including the 2 bytes of error event data and the additional 2 bytes of data are stored in the EEPROM 13. In the case of this error, if the light-on state is not continued, the microcomputer 12 reports the error by setting a Back light error flag of the Status message sent to the host 2.

in a case where a connection error of the LCD 14 (Display connection error) is detected, the microcomputer 12 stores “0101 (in binary number)” as error data. In this case, the microcomputer 12 reports an error by setting a Display connection error flag of the Status message sent to the host 2.

Also when an error in the LCD controller 17 that controls displaying of the LCD 14 is detected, the microcomputer 12 writes the error event data. In the example shown in FIG. 6, when an error (Source driver error) in a source driver for inputting a data signal to the LCD 14 is detected, “1000 (in binary number)” is stored as error data.

Software used on the microcomputer 12 can be updated from outside via the communication device 11. In a case where the microcomputer 12 detects an occurrence of a software update error (Software update error), the microcomputer 12, stores “0111 (in binary number)” as error data.

Although a description is omitted, it is possible to set unique error data for each of various other error events, and store error data in response to such an error event. In the present embodiment, the data length of the error data is 4 bits, and thus up to 16 types of error events can be set.

Storing of event data in the EEPROM 13 by the microcomputer 12 is started when, after the display module 1 is activated, a first Write message arrives. For example, when a turn-on event of the LED 15 occurs, event data thereof is stored. After that, each time the state of the display module 1 changes, event data is stored in the EEPROM 13, and each time an error is detected, event data is stored in the EEPROM 13.

In the present embodiment, the storage capacity of the EEPROM 13 is 4 Kbits, that is, 512 bytes. As shown in FIG. 3, when 2 bytes of the first area 131 for storing the link information and 2 bytes of the reserve area 135 for checking the operation of the EEPROM 13 are subtracted from 512 bytes, the remainder with 508 bytes is left as an area in which it is allowed to write event data. Approximately five pieces of event data can be written in one writing operation. If five pieces of event data are put together in one set, one set of event data has a size of 10 bytes because one piece of event data has 2 bytes. Therefore, about 50 sets of event data can be written in the EEPROM 13.

As shown in FIG. 4, in the event data, an area representing an event occurrence time (Time) has a length of 11 bits. Therefore, when time is represented in units of minutes, it is possible to represent time every minute from 0 to 2048 minutes. Therefore, about 34.1 hours can be covered after time measurement is once started.

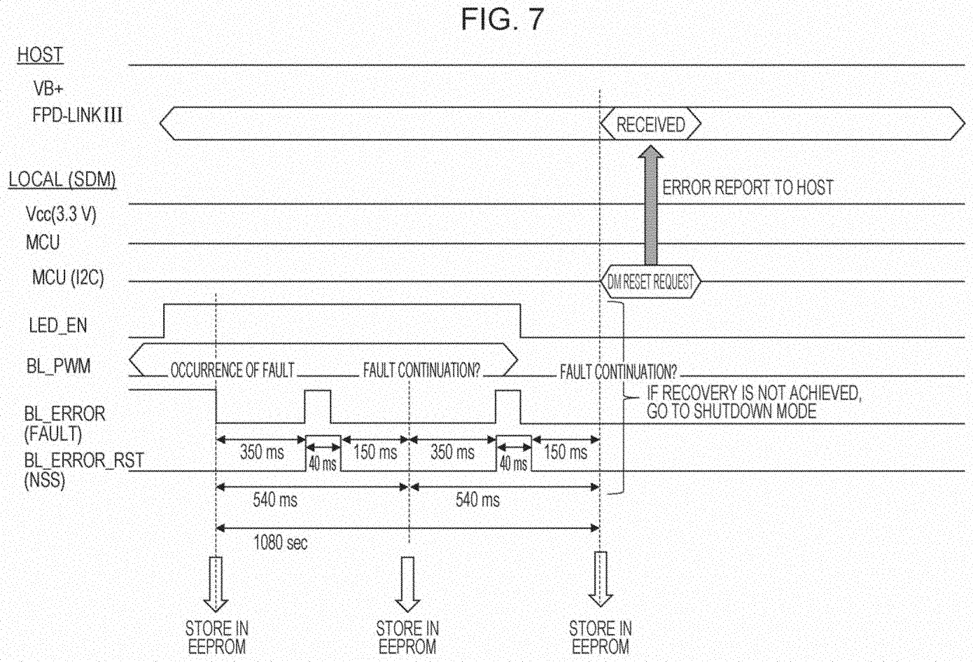

Next, a sequence of writing data in the EEPROM 13 is described below with reference to FIG. 7 for a case where the LED controller 18 is in an error state and is not recovered via a Fault handling operation.

The microcomputer 12 monitors a FAULT terminal (BL_ERROR) of the LED controller 18 while the enable signal (LED_EN) of the LED controller 18 is at a high level. When the microcomputer 12 detects a change in the BL_ERROR signal to a low level (that is, when FAULT occurs), the microcomputer 12 waits for a predetermined period of time (350 ms in the example shown in FIG. 7) to elapse, and, after that, the microcomputer 12 supplies a high level voltage to an NSS terminal (BL_ERROR_RST) of the LED controller 18 for a predetermined period of time (40 ms in the example shown in FIG. 7) thereby trying to reset FAULT. The microcomputer 12 waits for a further predetermined period of time (150 ms in the example shown in FIG. 7) to elapse. If the BL_ERROR signal still remains at the low level, the microcomputer 12 again performs the FAULT handling operation in a similar manner as described above.

If recovery is not achieved by the second FAULT handling operation, the microcomputer 12 goes to a shutdown mode and transmits a reset request for resetting the display module 1 to the host 2 via the video communication network 5 (FPD-LINK III in the example shown in FIG. 7).

In FIG. 7, downward arrows each indicate a timing at which the microcomputer 12 stores error event data in the EEPROM 13. As described above, by storing error event data indicating an occurrence of FAULT or a continuation of FAULT in the EEPROM 13 before a reset request is transmitted to the host 2, it becomes possible to, even after the display module 1 was removed from a vehicle, check what kind of event occurred in the display module 1 before an error report (a reset request) was transmitted to the host 2.

In the configuration according to the embodiment described above, it is assumed by way of example that the microcomputer 12 stores event data in the EEPROM 13. However, an internal memory of the microcomputer 12 may be used as a storage location for storing the event data. For example, a storage circuit such as a data flash memory may be provided in the microcomputer 12, and error data may be stored therein. The storage medium for storing event data is not limited to the EEPROM or the data flash, but any non-volatile memories may be used.

The configurations described above are summarized below.

### First Configuration]

According to a first configuration, there is provided an in-vehicle display device that is connected to a host via a video communication interface and that performs displaying under the control of the host, including a control unit that controls the display device, and a storage unit accessible by the control unit, wherein when the control unit detects an occurrence of an error in the display device, the control unit stores error event data representing the error in the storage unit.

According to the first configuration, the storage unit accessible by the control unit is provided in the in-vehicle display device, and, when the control unit detects an occurrence of an error in the display device, the error event data indicating the error is stored in the storage unit. This makes it possible to analyze a cause of the error by referring to the error event data stored in the storage unit via an analysis tool or the like even after the display device is removed from the vehicle.

### Second Configuration

In the display device according to a second configuration, based on the first configuration, the control unit may also store normal event data in addition to the error event data such that when a change in a state of the display device occurs, the control unit stores the normal event data representing the state in the storage unit.

According to the second configuration, not only the error event data but also the normal event data representing the state of the display device is stored in the storage unit when a change in the state of the display device occurs thereby making it possible to check states before and after the occurrence of the error. This makes it possible to determine the cause of the error more accurately.

### Third Configuration

in the display device according to a third configuration, based on the first or second configuration, the display device may further include a table describing error data uniquely assigned to each of a plurality of errors, wherein when the control unit detects an occurrence of an error in the display device, the control unit acquires error data corresponding to the error from the table and generates error event data.

According to the third configuration, by storing error data as an error ID that uniquely identifies a possible error in the display device in a table, it becomes possible to reduce the data size of the error event data compared to, for example, a case where various parameters representing an error event are included in error event data,

### Fourth Configuration

In the display device according to a fourth configuration, based on one of the first to third configurations, the storage unit may be a non-volatile memory. According to this configuration, error event data can be retained even when the power of the display device is cut off. Therefore, the error event data can be analyzed after the display device is removed from the vehicle.

### Fifth Configuration

In a fifth configuration according to one of the first to fourth configurations, the display device may be connected to an external error analysis tool via the video communication interface. According to this configuration, it is possible to connect to the error analysis tool via the same video communication interface as the video communication interface used to communicate with the host when the display device is in a vehicle. Thus, a further interface may not be provided for connecting to the error analysis tool.

The present disclosure contains subject matter related to that disclosed in Japanese Priority Patent Application JP 63-058879 filed in the Japan Patent Office on Jul. 30, 2020, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An in-vehicle display device that is connected to a host via a video communication interface and that performs displaying under the control of the host, comprising:
a control unit that controls the display device; and
a storage unit accessible by the control unit,
wherein when the control snit detects an occurrence of an error in the display device, the control unit stores error event data representing the error in the storage unit.

2. The display device according to claim 1, wherein the control unit also stores normal event data in addition to the error event data such that when a change in a state of the display device occurs, the control unit stores the normal event data representing the state in the storage unit.

3. The display device according to claim 1, further comprising a table describing error data uniquely assigned to each of a plurality of errors, wherein
when the control unit detects an occurrence of an error in the display device, the control unit acquires error data corresponding to the error from the table and generates error event data.

4. The display device according to one of claim 1, wherein the storage unit is a non-volatile memory.

5. The display device according to one of claim 1, wherein the display device can be connected to an external error analysis tool via the video communication interface.
